(19) United States
(12) Patent Application Publication
(10) Pub. No.: US 2025/0301149 A1
(43) Pub. Date: Sep. 25, 2025

(54) DERIVATION PROCESS FOR CHAINED MOTION VECTOR PREDICTION IN VIDEO CODING

(71) Applicant: QUALCOMM Incorporated, San Diego, CA (US)

(72) Inventors: Po-Han Lin, Taipei (TW); Jian-Liang Lin, Su'ao Township (TW); Zhi Zhang, Munich (DE); Vadim Seregin, San Diego, CA (US); Marta Karczewicz, San Diego, CA (US)

(21) Appl. No.: 19/043,678

(22) Filed: Feb. 3, 2025

Related U.S. Application Data
(60) Provisional application No. 63/567,828, filed on Mar. 20, 2024.

(51) Int. Cl. H04N 19/139; H04N 19/105; H04N 19/176; H04N 19/577

(52) U.S. Cl. CPC H04N 19/139; H04N 19/105; H04N 19/176; H04N 19/577

(57) ABSTRACT

An example video coder is configured to determine to decode a current block of the video data using a bilateral matching merge mode. The video coder is configured to determine a first chained motion vector prediction (CMVP) candidate based on a first source candidate and determine that the first source candidate satisfies one or more bilateral matching conditions. The video coder is configured to insert the first CMVP candidate into a bilateral matching merge list. The video coder is configured to determine a second CMVP candidate based on a second source candidate and determine that the second source candidate does not satisfy the one or more bilateral matching conditions. The video coder is configured to insert the second CMVP candidate into a second list. The video coder is configured to decode the current block using at least one of the bilateral matching merge list or the second list.

This application claims the benefit of U.S. Provisional Patent Application 63/567,828, filed Mar. 20, 2024, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for coding video data, including techniques for chained motion vector prediction (CMVP). This disclosure also describes different techniques (e.g., template type, fusion) and syntax used in template matching TM related tools. The techniques of this disclosure can be applied to any of the existing video codecs, such as HEVC (High Efficiency Video Coding), VVC (Versatile Video Coding), Essential Video Coding (EVC), or be an efficient coding tool in future video coding standards (e.g., ECM (Enhanced Compression Model)). Certain CMVP implementations and standards may not be optimally efficient ways of coding video data. The CMVP techniques of this disclosure may improve the efficiency of video coding and/or quality of video data. Improving the efficiency of video coding may decrease the processing and/or power consumption requirements of a video coder.

An example method includes: determining to code a current block of the video data using a bilateral matching merge mode; determining a first chained motion vector prediction (CMVP) candidate based on a first source candidate; determining that the first source candidate satisfies one or more bilateral matching conditions; inserting, based on the first source candidate satisfying the one or more bilateral matching conditions, the first CMVP candidate into a bilateral matching merge list; determining a second CMVP candidate based on a second source candidate; determining that the second source candidate does not satisfy the one or more bilateral matching conditions; inserting, based on the second source candidate not satisfying the one or more bilateral matching conditions, the second CMVP candidate into a second list; and coding the current block using at least one of the bilateral matching merge list or the second list.

An example device includes one or more memories configured to store the video data; and one or more processors communicatively coupled to the one or more memories, the one or more processors configured to: determine to decode a current block of the video data using a bilateral matching merge mode; determine a first chained motion vector prediction (CMVP) candidate based on a first source candidate; determine that the first source candidate satisfies one or more bilateral matching conditions; insert, based on the first source candidate satisfying the one or more bilateral matching conditions, the first CMVP candidate into a bilateral matching merge list; determine a second CMVP candidate based on a second source candidate; determine that the second source candidate does not satisfy the one or more bilateral matching conditions; insert, based on the second source candidate not satisfying the one or more bilateral matching conditions, the second CMVP candidate into a second list; and decode the current block using at least one of the bilateral matching merge list or the second list.

Another example device includes one or more memories configured to store the video data; and one or more processors communicatively coupled to the one or more memories, the one or more processors configured to: determine to encode a current block of the video data using a bilateral matching merge mode; determine a first chained motion vector prediction (CMVP) candidate based on a first source candidate; determine that the first source candidate satisfies one or more bilateral matching conditions; insert, based on the first source candidate satisfying the one or more bilateral matching conditions, the first CMVP candidate into a bilateral matching merge list; determine a second CMVP candidate based on a second source candidate; determine that the second source candidate does not satisfy the one or more bilateral matching conditions; insert, based on the second source candidate not satisfying the one or more bilateral matching conditions, the second CMVP candidate into a second list; and encode the current block using at least one of the bilateral matching merge list or the second list.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2A is a conceptual diagram illustrating example spatial motion vector candidates for a merge mode.

FIG. 2B is a conceptual diagram illustrating example spatial motion vector candidates for an advanced motion vector prediction (AMVP) mode.

FIG. 3A is a conceptual diagram illustrating example of a temporal motion vector candidate.

FIG. 3B is a conceptual diagram illustrating an example of motion vector scaling.

FIG. 4 illustrates an example of template matching on a search area around an initial motion vector.

FIG. 5 illustrates one example of bilateral matching prediction where two motion vectors are proportional based on temporal distances.

FIG. 6 illustrates one example of bilateral matching prediction where two motion vectors are mirrored regardless of temporal distances.

FIG. 7 illustrates an example of a 3×3 square search pattern in the search range [−8,8].

FIG. 8 illustrates an example of decoder-side motion vector refinement.

FIG. 9 illustrates an example derivation of a chained motion vector prediction (CMVP) candidate.

FIG. 10 illustrates an example operation of referencing source and destination tracing motion vectors in CMVP.

FIG. 11 illustrates an example of CMVP motions with trace depth of one.

FIG. 12 is a flowchart illustrating an example of chained motion vector prediction techniques according to one or more aspects of this disclosure.

FIG. 13 is a flowchart illustrating another example of chained motion vector prediction techniques according to one or more aspects of this disclosure.

FIG. 14 is a block diagram illustrating an example video encoder that may perform the techniques of this disclosure.

FIG. 15 is a block diagram illustrating an example video decoder that may perform the techniques of this disclosure.

FIG. 16 is a flowchart illustrating an example method for encoding a current block in accordance with the techniques of this disclosure.

FIG. 17 is a flowchart illustrating an example method for decoding a current block in accordance with the techniques of this disclosure.

### DETAILED DESCRIPTION

This disclosure describes techniques for coding video data, including techniques for chained motion vector prediction (CMVP). Certain CMVP implementations and standards may not be optimally efficient ways of coding video data. The CMVP techniques of this disclosure may improve the efficiency of video coding and/or quality of video data. Improving the efficiency of video coding may decrease the processing and/or power consumption requirements of a video coder.

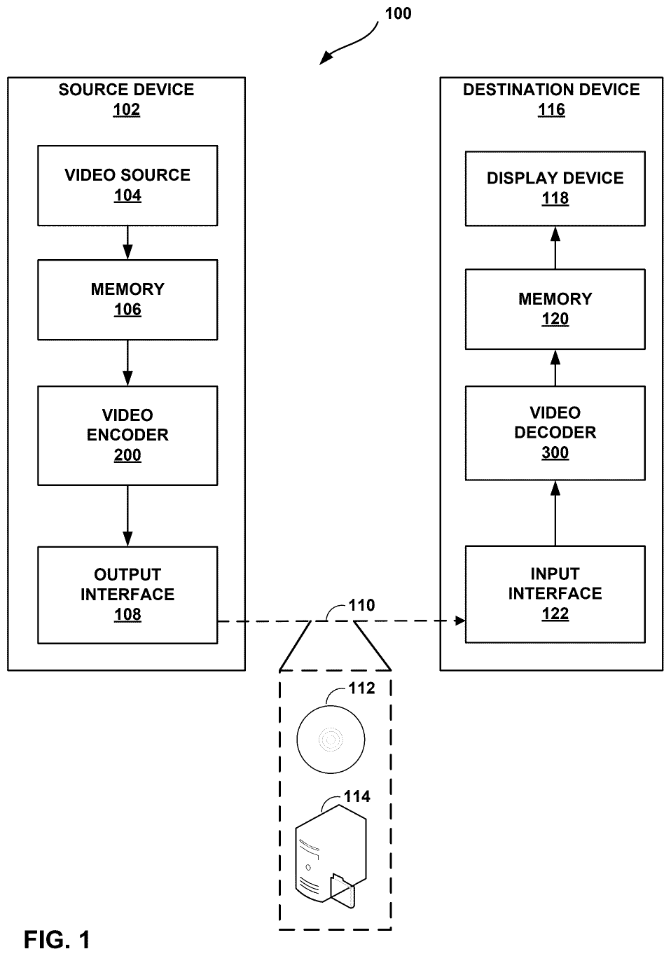

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for chained motion vector prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for chained motion vector prediction. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally, or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (cMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use chained motion vector prediction.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In general, this disclosure describes techniques for coding video data, including techniques for chained motion vector prediction (CMVP). This disclosure describes different techniques (e.g., template type, fusion) and syntax used in template matching TM related tools. The techniques of this disclosure can be applied to any of the existing video codecs, such as HEVC (High Efficiency Video Coding), VVC (Versatile Video Coding), Essential Video Coding (EVC), or be an efficient coding tool in future video coding standards (e.g., ECM (Enhanced Compression Model)). In the following section, HEVC, Joint Exploration Model (JEM) techniques and works in Versatile Video Coding (VVC) related to the techniques of this disclosure are reviewed.

CU structure and motion vector prediction in HEVC is now discussed. In HEVC, the largest coding unit in a slice is a CTB, also called a CTU. A CTB contains a quad-tree, the nodes of which are CUs. The size of a CTB can typically range from 16×16 to 64×64 in the HEVC main profile, although in some scenarios 8×8 CTB sizes may also be supported. A CU may range in size from being the same size as a CTB to as small as 8×8. Each CU is encoded with one coding mode, e.g., inter or intra. When a CU is inter coded, the CU may be further partitioned into 2 or 4 PUs or become just one PU if further partitioning is not applied. When two PUs are present in one CU, the two PUs can be half size rectangles or two rectangles with sizes of ¼ or ¾ the size of the CU.

When the CU is inter coded, each PU has one set of motion information, which is derived with a unique inter prediction mode.

Motion vector prediction is now described. In the HEVC standard, there are two inter prediction modes, referred to as merge mode (with skip mode being considered a special case of merge mode) and AMVP mode, respectively, for a PU.

In either AMVP or merge mode, video encoder 200 and video decoder 300 may be configured to maintain a motion vector (MV) candidate list, with the list including multiple motion vector predictors. Video encoder 200 and video decoder 300 may be configured to generate the motion vector(s), as well as reference indices in the merge mode, for the current PU by selecting a candidate from the MV candidate list.

In HEVC, the MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, video encoder 200 and video decoder 300 may be configured to determine the reference pictures used for the prediction of the current blocks, as well as the associated motion vectors, based on the selected candidate. For AMVP mode, in contrast, for each potential prediction direction from either list 0 or list 1, a reference index is explicitly signaled (e.g., by video encoder 200 to video decoder 300), together with an MV predictor (MVP) index to the MV candidate list. In AMVP mode, the predicted motion vectors can be further refined by, for example, receiving a motion vector differences that can be added to the MVP. The candidates for the candidate lists in both modes may be derived similarly from the same spatial and temporal neighboring blocks.

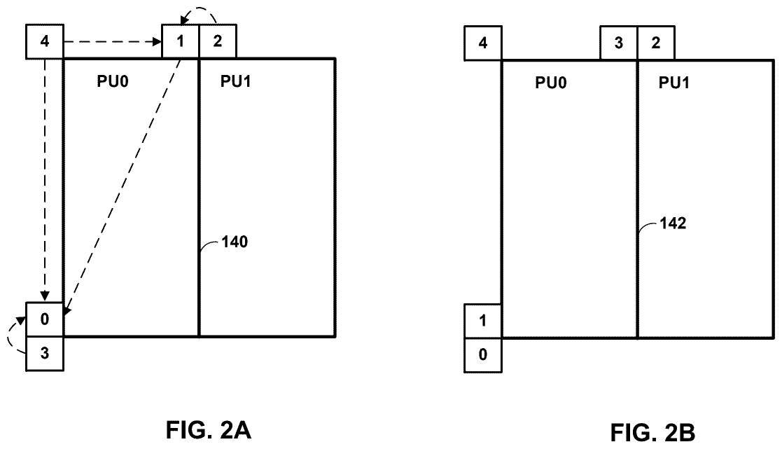

Spatial neighbor candidates are now described. FIG. 2A is a conceptual diagram showing an example of spatial neighboring motion vector candidates for merge mode. Video decoder 300 may generate a candidate list by adding the motion information of spatial neighboring candidates to the candidate list. Spatial MV candidates are derived from the neighboring blocks shown in FIGS. 2A and 2B, for a specific PU (PU0), although the processes for generating the candidates from the blocks may differ for merge and AMVP modes. In merge mode, up to five spatial MV candidates can be derived for block 140 (PU0) with the orders shown in FIG. 2A. The order is the following: left (0), above (1), above right (2), below left (3), and above left (4), as shown in FIG. 2A.

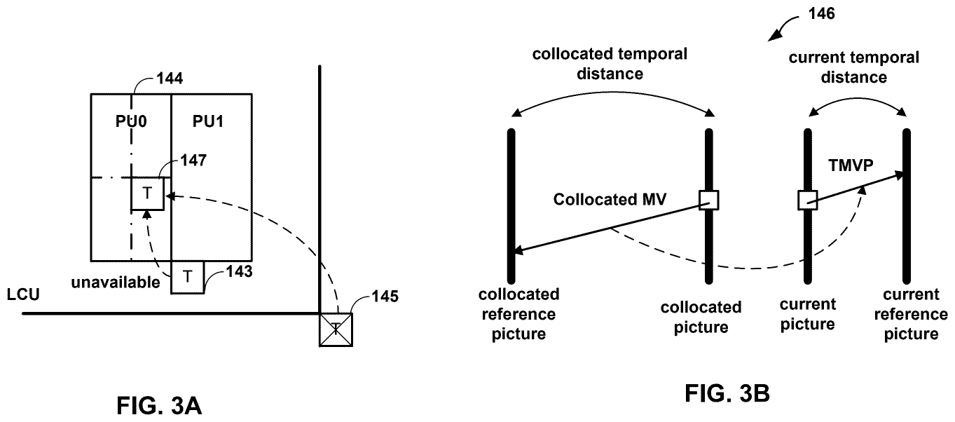

FIG. 2B is a conceptual diagram showing an example of spatial neighboring motion vector candidates for AMVP. In AMVP mode, the neighboring blocks of block 142 (PU0) are divided into two groups: a left group including block 0 and 1, and an above group including blocks 2, 3, and 4, as shown in FIG. 3B. For each group, the potential candidate in a neighboring block referring to the same reference picture as that indicated by the signaled reference is prioritized to form a final candidate of the group. It is possible that all neighboring blocks do not contain a motion vector pointing to the same reference picture. Therefore, if such a candidate cannot be found, the first available candidate may be scaled to form the final candidate, allowing the temporal distance differences to be compensated.

Temporal motion vector prediction in HEVC is now described. Video encoder 200 and video decoder 300 may be configured to add a temporal motion vector predictor (TMVP) candidate, if enabled and available, into the MV candidate list after spatial motion vector candidates are added. The process of motion vector derivation for a TMVP candidate may be the same for both merge and AMVP modes. However, in HEVC, the target reference index for the TMVP candidate in the merge mode may be set to 0.

FIG. 3A is a conceptual diagram showing an example of a TMVP candidate. The primary block location for TMVP candidate derivation for block 144 (PU0) is the bottom right block outside of the collocated PU, which is shown as block “T” in FIG. 3A, to compensate the bias to the above and left blocks used to generate spatial neighboring candidates. However, if that block is located outside of the current CTB row (e.g., like block 145) or motion information is not available (e.g., like block 143), the block is substituted with a center block 147 of the PU.

Video decoder 300 may derive a motion vector for the TMVP candidate from the co-located PU of the co-located picture, indicated at a slice level. The motion vector for the co-located PU is called the collocated MV. A block in a reference picture may, for example, be considered to be co-located to a block in a current picture if the block in the reference picture and the current block each include at least one pixel corresponding to a same relative position in the reference picture and the current picture.

FIG. 3B is a conceptual timing diagram showing an example of motion vector scaling process 146. Similar to temporal direct mode in AVC, to derive the TMVP candidate motion vector, video decoder 300 may scale the co-located MV to compensate for the temporal distance differences, as shown in FIG. 3B.

Other aspects of motion prediction in HEVC are now described. With motion vector scaling, it is generally assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is typically calculated based on the Picture Order Count (POC) values.

For a motion vector being predicted, the associated containing picture and reference picture may be different. Therefore, a new distance based on POC may be calculated, and the motion vector may be scaled based on the two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Video encoder 200 and video decoder 300 may be configured to perform artificial motion vector candidate generation. If a motion vector candidate list is not complete (e.g., the motion vector candidate list contains less than some predetermined number of candidates), artificial motion vector candidates may be generated and inserted at the end of the list until the list has the designated number of candidates.

In merge mode, there are two types of artificial MV candidates: combined candidates derived only for B-slices and zero motion vector candidates used for AMVP if the first type does not provide enough artificial candidates.

For each pair of candidates that are already in the candidate list and have necessary motion information, bi-directional combined motion vector candidates may be derived by a combination of the motion vector of the first candidate referring to a picture in the list 0 and the motion vector of a second candidate referring to a picture in the list 1.

Video encoder 200 and video decoder 300 may be configured to perform a pruning process for candidate insertion. Candidates from different blocks may happen to be the same, which decreases the efficiency of a merge/AMVP candidate list. A pruning process may be applied to solve this problem. The pruning process compares one candidate against the others in the current candidate list to avoid inserting an identical candidate, to a certain extent. For example, to reduce the complexity, only limited numbers of pruning processes are applied instead of comparing each potential candidate with all the other existing candidates.

Template matching prediction is now described. Video encoder 200 and video decoder 300 may be configured to perform template matching TM prediction. TM prediction is a special merge mode based on Frame-Rate Up Conversion (FRUC) techniques. In this mode, motion information for a block is not signaled (e.g., by video encoder 200), but is derived at decoder side (e.g., by video decoder 300). TM prediction may be applied to both AMVP mode and regular merge mode. In AMVP mode, MVP candidate selection is determined based on template matching to identify a candidate that results in the minimal difference between a current block template and a reference block template. In regular merge mode, a TM mode flag may be signaled to indicate the use of TM, and then TM may be applied to the merge candidate indicated by merge index for MV refinement.

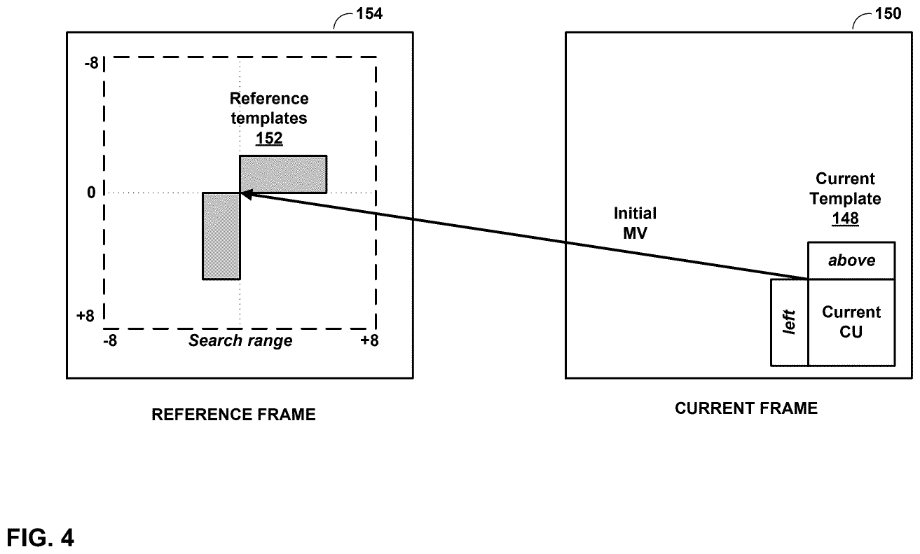

FIG. 4 illustrates an example of template matching on a search area around an initial motion vector. As shown in FIG. 4, video encoder 200 and video decoder 300 may be configured to use template matching to derive motion information of the current CU by finding the closest match between current template 148 (top and/or left neighboring blocks of the current CU) in current picture 150 and a template within reference templates 152 for a reference block (that may be a same size as current template 148) in reference picture 154. With an AMVP candidate selected based on initial matching error, video encoder 200 and video decoder 300 may refine the MVP with template matching. With a merge candidate indicated by a signaled merge index, the merged MVs corresponding to L0 and L1 may be refined independently by template matching. The less accurate of the merged MV may then be further refined based on the more accurate merged MV.

Video encoder 200 and video decoder 300 may be configured to implement a cost function. When a motion vector points to a fractional sample position, motion compensated interpolation may be needed. To reduce complexity, bi-linear interpolation, instead of regular 8-tap DCT-IF interpolation, may be used for both template matching to generate templates in reference pictures. An example matching cost C for template matching may be calculated as follows:

$$C = SAD + w \cdot ( \vert {MV}_{x} - M {V}_{x}^{s} \vert + \vert {MV}_{y} - M {V}_{y}^{s} \vert ) ,$$

where w is a weighting factor which is empirically set to 4, MV and MVS indicate the currently testing MV and the initial MV (e.g., an MVP candidate in AMVP mode or a merged MV in merge mode), respectively. SAD is used as the matching cost of template matching.

When TM is used, video encoder 200 and video decoder 300 may be configured to refine the MV (e.g., the initial MV) using luma samples only. The MV determined based on the refinement, however, may be used for both luma and chroma for motion compensation (MC) inter prediction. After a MV is determined, final MC may be performed using an 8-tap interpolation filter for luma and a 4-tap interpolation filter for chroma.

Video encoder 200 and video decoder 300 may be configured to implement a search process. MV refinement may include a pattern-based MV search process with the criterion of template matching cost and utilizing a hierarchical structure. Two search patterns are supported-a diamond search and a cross search for MV refinement. The hierarchical structure specifies an iterative process to refine a MV, starting at a coarse MV precision (e.g., quarter-pel) and ending at a finer precision (e.g., ⅛-pel). For example, a quarter-pel MV precision implies that a template matching process is performed on a search area around an initial MV to identify a refined MV where a step size of the search uses a quarter of a luma-sample distance (or resolution) as the motion vector difference (MVD) precision (between the initial MV and the refined MV). The MV is directly searched at a quarter luma sample MVD precision with a diamond pattern, followed by quarter luma sample MVD precision with a cross pattern, and then this is followed by one-eighth luma sample MVD refinement with cross pattern. The search range of MV refinement is set equal to (−8, +8) luma samples around the initial MV. When the current block is of bi-prediction (e.g., a bi-predicted block), both MVs are refined independently, and then the best of which (in terms of matching cost) is set as a prior (e.g., a basis) to further refine the other MV with bi-prediction with CU-level weight (BCW) weight values.

Bilateral matching prediction is now described. Video encoder 200 and video decoder 300 may be configured to perform bilateral matching prediction. Bilateral matching, also referred to as bilateral merge, (BM) prediction is another merge mode based on FRUC techniques. When applying BM mode to a block, video encoder 200 and video decoder 300 may derive two initial motion vectors MV0 and MV1 using a signaled merge candidate index to select the merge candidate in a constructed merge list. When implementing bilateral matching, video encoder 200 and video decoder 300 search around the MV0 and MV1 and derive the final MV0′ and MV1′ based on a minimum bilateral matching cost.

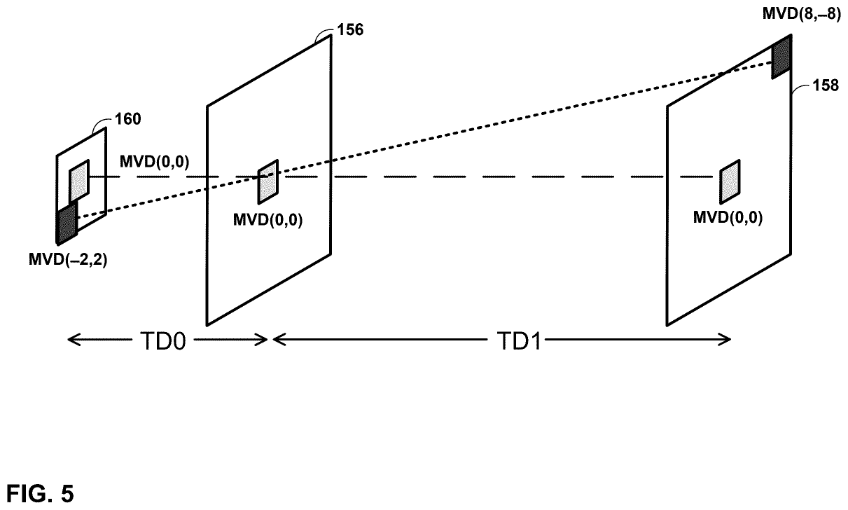

The motion vector difference MVD0 (denoted by MV0′-MV0) and MVD1 (denoted by MV1′-MV1) pointing to the two reference blocks may be proportional to the temporal distances (TD), e.g. TD0 and TD1, between the current picture and the two reference pictures. FIG. 5 illustrates one example of bilateral matching prediction where two motion vectors are proportional based on temporal distances. In FIG. 5, the distance (TD1) between current picture 156 and reference picture 158 is 4-times the distance (TD0) between current picture 156 and reference picture 160. In this example, MVD0 and MVD1 are proportional based on the temporal distances.

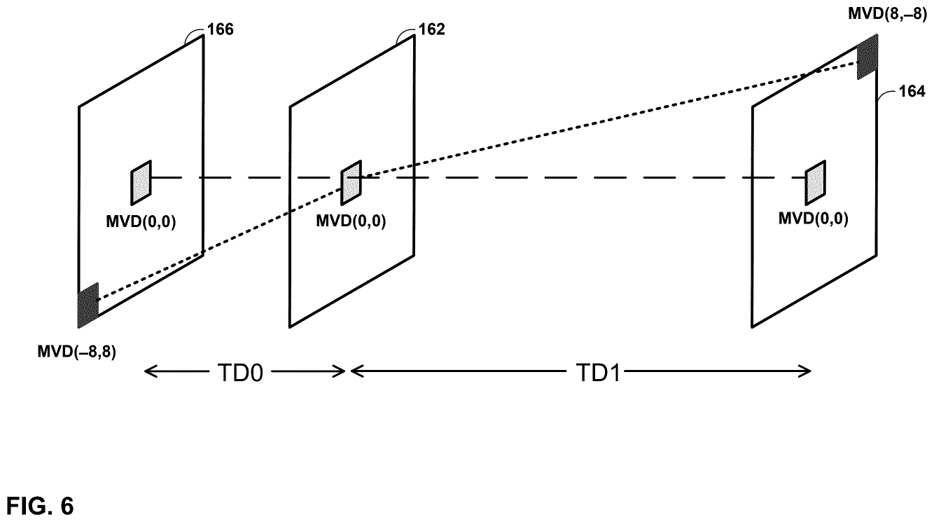

However, there is an optional design where MVD0 and MVD1 are mirrored regardless of the temporal distances TD0 and TD1. FIG. 6 illustrates one example of bilateral matching prediction where two motion vectors are mirrored regardless of temporal distances. In FIG. 6, MVD0 and MVD1 are shown as mirrored regardless of the temporal distance (TD1) between current picture 162 and reference picture 164 and the temporal distance (TD0) between current picture 162 and reference picture 166. For example, FIG. 6 shows an example of mirrored MVD0 and MVD1, where TD1 is 4-times of TD0.

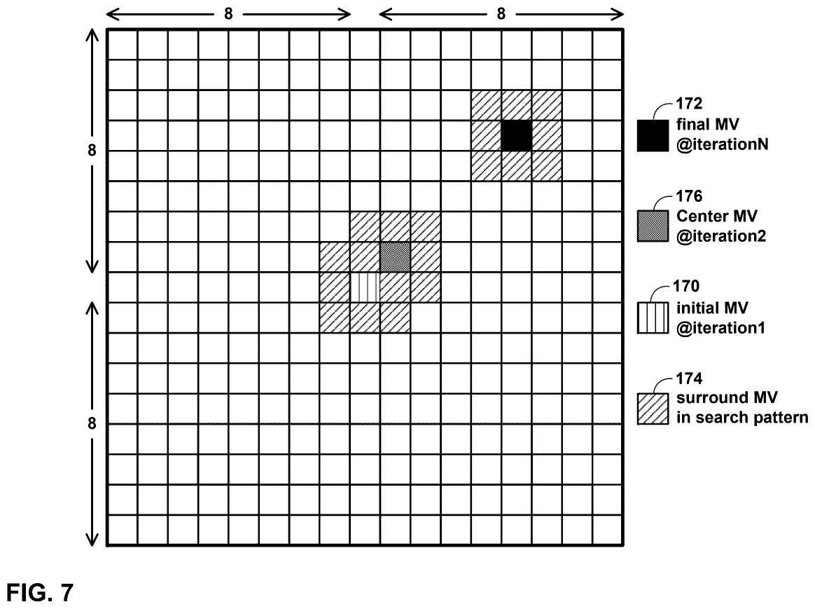

FIG. 7 illustrates an example of a 3×3 square search pattern in the search range [−8, 8]. The search pattern and search range of FIG. 7 may be used for implementing bilateral matching. When implementing bilateral matching, video encoder 200 and video decoder 300 may be configured to perform a local search around the initial MV0 and MV1 to derive the final MV0′ and MV1′. In the example of FIG. 7, the initial MV points to sample 170, and the final MV points to sample 172. The local search applies a 3×3 square search pattern to loop through the search range [−8, 8]. Samples 174 represent examples of samples in the search range around samples 170, 172, and sample 176. Sample 176 represents an example of a sample corresponding to a MV determined during an intermediate iteration of the search process. In each search iteration, the bilateral matching cost of the eight surrounding MVs in the search pattern are calculated and compared to the bilateral matching cost of center MV. The MV which has minimum bilateral matching cost becomes the new center MV in the next search iteration. The local search is terminated when the current center MV has a minimum cost within the 3×3 square search pattern or the local search reaches the pre-defined maximum search iteration.

Bilateral matching AMVP-merge mode is now described. The bi-directional predictor is composed of an AMVP predictor in one direction and a merge predictor in the other direction. Bilateral matching AMVP-merge mode can be enabled to a coding block when the selected merge predictor and the AMVP predictor satisfy a decoder-side motion vector refinement (DMVR) condition, where there is at least one reference picture from the past and one reference picture from the future relative to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

The AMVP part of the bilateral matching AMVP-merge mode is signaled as a regular uni-directional AMVP, e.g., the reference index and MVD are signaled, and it has a derived MVP index if template matching is used or MVP index is signaled when template matching is disabled.

For AMVP direction LX, X can be 0 or 1. The merge part in the other direction (1-LX) is implicitly derived by minimizing the bilateral matching cost between the AMVP predictor and a merge predictor, e.g., for a pair of the AMVP and a merge motion vectors. For every merge candidate in the merge candidate list which has that other direction (1-LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is sub-PU bi-directional optical flow (BDOF) refinement of the multi-pass DMVR is enabled to AMVP-merge mode coded block. The sub-PU size of BDOF is adaptively selected depending on the width×height. For blocks smaller than 256, subblock size of 4×4, and otherwise 8×8 is used. In addition, the following high-precision equations to derive the BDOF MV refinement parameters are utilized:

$$\begin{matrix}\sum Gx . Gx * vx + \sum Gx . Gy * vy = \sum dI . Gx ⇒ s 1 * vx + s 2 * vy = s 3 \\ \sum Gx . Gy * vx + \sum Gy . Gy * vy = \sum dI . Gy ⇒ s 2 * vx + s 5 * vy = s 6 ,\end{matrix}$$

where Gx/Gy are the summation of the 2 horizontal/vertical gradients derived for each reference block. Summations (Σ) are weighted sums, where weights depend on the position in the target region Ω. The weights can also be applied to derive vx/vy in other cases.

Bilateral matching AMVP-merge mode is indicated by a flag. If the mode is enabled, the AMVP direction LX is further indicated by a flag.

When bilateral matching (BM) AMVP-merge mode is used for the current block and template matching is enabled, an MVD is not signalled. An additional pair of AMVP-merge MVPs is introduced. The merge candidate list is sorted based on the BM cost in increase order. An index (0 or 1) is signaled (e.g., by video encoder 200 to video decoder 300) to indicate which merge candidate in the sorted merge candidate list to use. When there is only one candidate in merge candidate list, the pair of AMVP MVP and merge MVP without bilateral matching MV refinement is padded.

Adaptive decoder-side motion vector refinement is now described. Adaptive decoder side motion vector refinement is an extension of multi-pass DMVR which includes the two new merge modes to refine a MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR. Video encoder 200 and video decoder 300 may be configured to use adaptive decoder-side motion vector refinement.

The merge candidates for the new merge mode are derived from spatial neighboring coded blocks, TMVPs, non-adjacent blocks, history-based motion vector predictors (HMVPs), pair-wise candidate, similar to as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using mean-removed sum of absolute differences (MRSAD) or mean-removed sum of transformed differences (MRSATD) if the weights are non-equal and the bi-prediction is weighted with BCW weights. A merge index is coded as in regular merge mode.

Decoder-side motion vector refinement (DMVR) is now described. Video encoder 200 and video decoder 300 may be configured to perform DMVR. In VVC, DMVR may be applied to increase the accuracy of the MVs of the merge mode. In bi-prediction operation, a refined MV is searched around the initial MVs in the reference picture list L0 and reference picture list L1. The DMVR process calculates the distortion between the two candidate blocks in the reference picture list L0 and list L1.

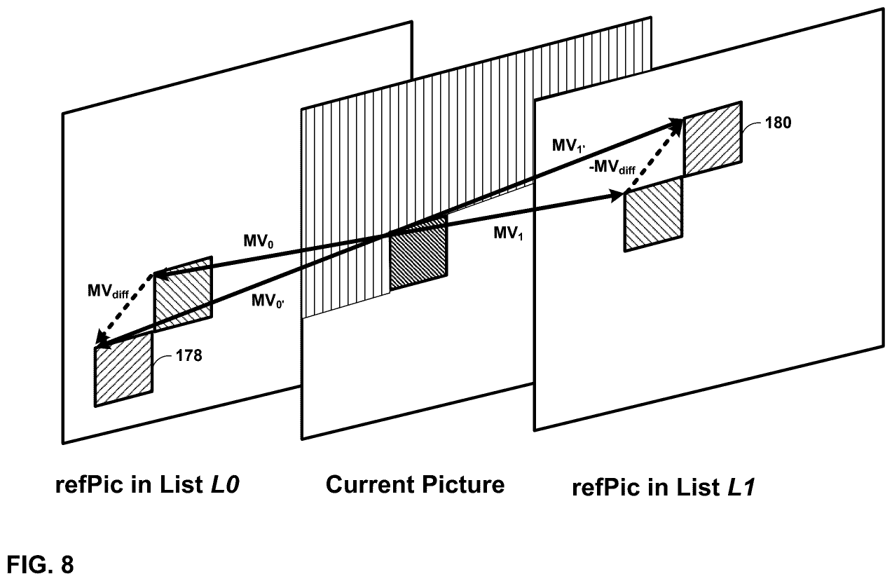

FIG. 8 shows an example of decoder-side motion vector refinement. As illustrated in FIG. 8, video encoder 200 and video decoder 300 may be configured to calculate the SAD between block 178 and block 180 based on each MV candidate around the initial MV. The MV candidate with the lowest SAD becomes the refined MV and used to generate the bi-predicted signal.

The refined MV derived by the DMVR process is used to generate the inter prediction samples and also used in temporal motion vector prediction for future picture coding. While the original MV is used in deblocking processes and also used in spatial motion vector prediction for future CU coding. DMVR is a subblock-based merge mode with a pre-defined maximum processing unit of 16×16 luma samples. When the width and/or height of a CU are larger than 16 luma samples, the CU may be further split into subblocks with width and/or height equal to 16 luma samples.

A searching scheme is now described. Video encoder 200 and video decoder 300 may be configured to implement a searching scheme. In DMVR, the search points are surrounding the initial MV and the MV offset obey the MV difference mirroring rule. In other words, any points that are checked by DMVR, denoted by candidate MV pair (MV0, MV1) obev the following two equations:

$$\begin{matrix}MV {0}^{′} = MV 0 + MV\_offset \\ MV {1}^{′} = MV 1 - MV\_offset\end{matrix}$$

Where MV_offset represents the refinement offset between the initial MV and the refined MV in one of the reference pictures. In DMVR, the refinement search range is two integer luma samples from the initial MV. The searching includes the integer sample offset search stage and fractional sample refinement stage.

Video encoder 200 and video decoder 300 may be configured to apply a 25-point full search for integer sample offset searching. The SAD of the initial MV pair is first calculated. If the SAD of the initial MV pair is smaller than a threshold, the integer sample offset search stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, video encoder 200 and video decoder 300 may favor the original MV during the DMVR process. The SAD between the reference blocks referred by the initial MV candidates is decreased by ¼ of the SAD value.

Following the integer sample search, video encoder 200 and video decoder 300 may be configured to perform fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C ,$$

where (xₘᵢₙ,yₘᵢₙ) corresponds to the fractional position with the least cost and C corresponds to the minimum cost value. By solving the above equations by using the cost value of the five search points, the (xₘᵢₙ, yₘᵢₙ) is computed as:

$$\begin{matrix}{x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \\ {y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )\end{matrix}$$

The value of xₘᵢₙ and yₘᵢₙ are automatically constrained to be between −8 and 8 since all cost values are positive and the smallest value is E(0,0). This corresponds to a half-pel offset with 1/16th-pel MV precision in VVC. The computed fractional (xₘᵢₙ) yₘᵢₙ) are added to the integer distance refinement MV to get the sub-pixel accurate refinement delta MV.

Bilinear-interpolation and sample padding are now described. Video encoder 200 and video decoder 300 may be configured to perform bilinear-interpolation and sample padding. In VVC, the maximum resolution of the MVs is 1/16 luma samples. The samples at the fractional position are interpolated using an 8-tap interpolation filter. In DMVR, the search points are surrounding the initial fractional-pel MV with an integer sample offset, therefore the samples of those fractional position may need to be interpolated for DMVR search process. To reduce the calculation complexity, the bi-linear interpolation filter may be used to generate the fractional samples for the searching process in DMVR. Another important effect of using a bi-linear filter is that with 2-sample search range, the DMVR does not access more reference samples compared to the normal motion compensation process. After the refined MV is attained with DMVR search process, the normal 8-tap interpolation filter may be applied to generate the final prediction. In order to not access more reference samples to normal MC process, the samples, which are not needed for the interpolation process based on the original MV but are needed for the interpolation process based on the refined MV, may be padded from those available samples.

Enabling conditions are now described. Video encoder 200 and video decoder 300 may be configured to implement one or more enabling conditions for DMVR. In one example, video encoder 200 and video decoder 300 may be configured to enable DMVR if the following conditions are all satisfied, e.g., present or true.
CU level merge mode with bi-prediction MV
One reference picture is in the past and another reference picture is in the future with respect to the current picture.
The distances (e.g., POC difference) from both reference pictures to the current picture are same
CU has more than 64 luma samples
Both CU height and CU width are larger than or equal to 8 luma samples
BCW weight index indicates equal weight
Weighted prediction (WP) is not enabled for the current block
Combined intra and inter prediction (CIIP) mode is not used for the current block

Chained motion vector prediction (CMVP) is now described. CMVP is a technique to derive the merge candidates for inter merge candidate list construction. Video encoder 200 and video decoder 300 may be configured to use CMVP.

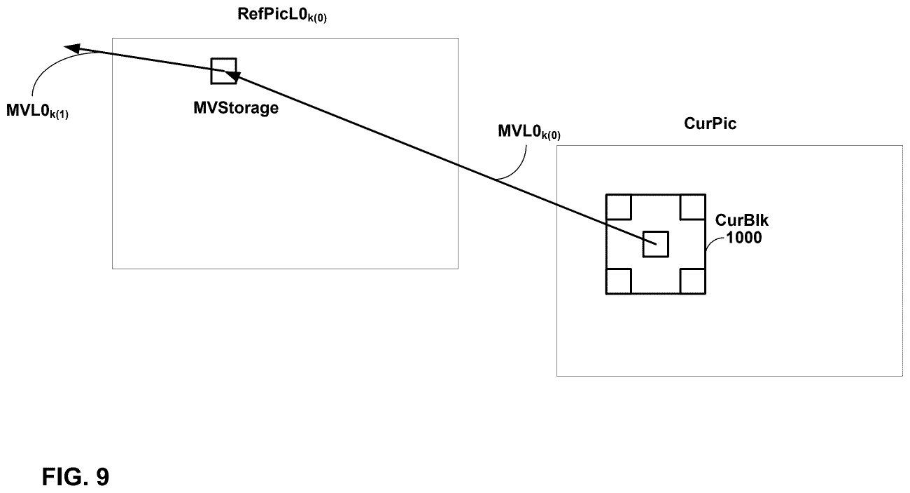

FIG. 9 illustrates an example derivation of a CMVP candidate. As shown in the CMVP techniques 900 of FIG. 9, CMVP candidates can be derived as the accumulation of the recursively traced MVs and block vectors (BVs) based on the pre-derived MVs for the inter merge candidate list. For instance, for a CMVP candidate, a set of motion vector MV_{k/m a}nd reference picture RefPic_{k/m} can be derived by:

$$\begin{matrix}{MV}_{k / m} = {MV}_{k ( 0 )} + {BV}_{k ( 0 )} + {MV}_{k ( 1 )} + {MV}_{k ( 2 )} + … + {MV}_{k ( m )} , \\ {RefPic}_{k / m} = {RefPic}_{k ( m )} ,\end{matrix}$$

where k and m indicate the number of merge index and trace depths of the CMVP.

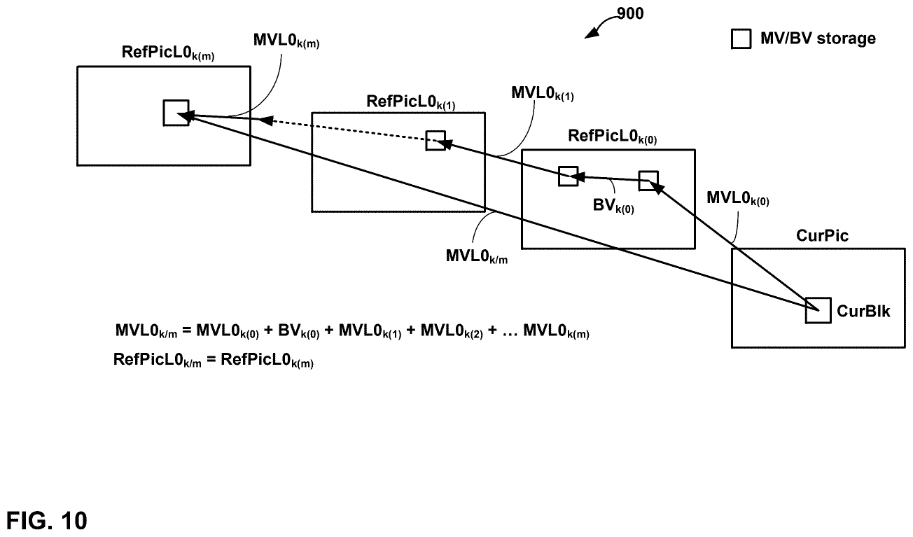

FIG. 10 illustrates an example operation of referencing source and destination tracing motion vectors in CMVP. When deriving MV_{w/m}, MVₖ₍ₘ₎ may be found by checking the existence of MVs or BVs in MV/BV storage corresponding to all five positions of the current block, as shown in FIG. 10 (e.g., the center, top-left, top-right, bottom-left, and bottom-right of the current block 1000).

When pre-derived merge candidates targeting CMVP candidates has two MVs, a MV_{k/m} is derived for each merge index, each list (i.e., L0 and L1), and each trace depth. Up to two MVs can be derived for each list and each trace depth, and the MV set is sequentially inserted into an inter merge candidate list.

The traceable reference pictures are only within the reference picture list. CMVP candidates are inserted after HMVP candidates for the regular merge and TM merge. When deriving CMVP candidates, hpellfIdx, bcwIdx, licFlag, and mhpFlag are not inherited. CMVP candidates are not derived when the TMVP is disabled.

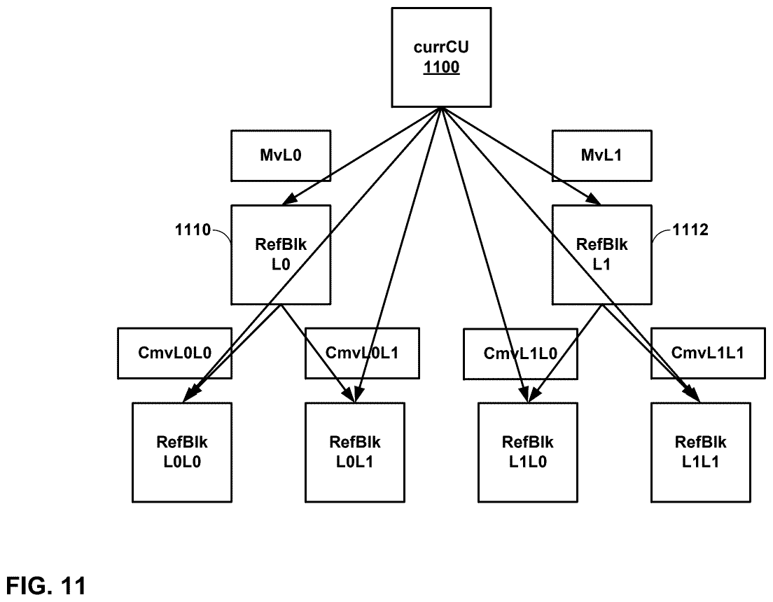

FIG. 11 illustrates an example of CMVP motions with trace depth of one. As shown in FIG. 11, if the source motion is bi-prediction for a current block (currCU) 1100, two reference blocks RefBlkL0 1110 and RefBlkL1 1112 are found and at most 4 chained motion vectors could be traced if the both reference blocks RefBlkL0 1110 and RefBlkL1 1112 are also bi-prediction blocks.

To improve the coding efficiency of chained motion vector prediction, one or more of the following techniques may be used to derive the chained motion vector prediction in different merge modes. Video encoder 200 and/or video decoder 300 may be configured to use any of, or any combination of, the following techniques.

CMVP in a candidate list of bilateral matching merge mode is now discussed. In one example of this disclosure, a bilateral matching merge mode candidate has at least one MV that is derived using CMVP. In this example, at least one CMVP candidate of a BM candidate is derived from a source candidate, wherein the source candidate meets the BM mode conditions. The BM mode conditions may include one or more of the DMVR mode conditions set forth above. In some examples, the BM mode conditions may be the same as the DMVR mode conditions. In this example, at least one CMVP candidate of a BM candidate is derived from a source candidate, wherein the source candidate does not meet the BM mode conditions. The source candidate is from, e.g., spatial neighbour, temporal neighbour (tmvp), non-adjacent neighbour, etc.

In one example, a flag is signaled to indicate whether the bilateral matching merge mode is selected or not for this block. For example, video encoder 200 may signal the flag to video decoder 300 in a bitstream. If bilateral matching merge mode is selected, when deriving the merge candidate list, only the bi-prediction candidates are inserted to the bilateral matching merge list.

In another example, when deriving the bilateral matching candidate list, only the bi-prediction candidates in which the two reference frames satisfy the conditions that one of the reference frame is in the past and the other reference frame is in the future with respect to the current frame are inserted to the bilateral matching merge list.

In another example, when deriving the bilateral matching candidate list, only the bi-prediction candidates in which the two reference frames satisfy the conditions that one of the reference frame is in the past and the other reference frame is in the future with respect to the current frame, and the POC differences from two reference frames to the current frame are the same, are inserted to the bilateral matching merge list.

In another example, when deriving the bilateral matching merge candidate list, if a candidate satisfies the bilateral matching conditions, the candidate is inserted to the bilateral matching merge list. If the candidate does not satisfy the bilateral matching conditions, the candidate is inserted to a second list.

For example, video encoder 200 or video decoder 300 may determine to code a current block of the video data using a bilateral matching merge mode. Video encoder 200 or video decoder 300 may determine a first CMVP candidate based on a first source candidate. Video encoder 200 or video decoder 300 may determine that the first source candidate satisfies one or more bilateral matching conditions. Video encoder 200 or video decoder 300 may insert, based on the first source candidate satisfying the one or more bilateral matching conditions, the first CMVP candidate into a bilateral matching merge list. Video encoder 200 or video decoder 300 may determine a second CMVP based on a second source candidate. Video encoder 200 or video decoder 300 may determine that the second source candidate does not satisfy the one or more bilateral matching conditions. Video encoder 200 or video decoder 300 may insert, based on the second source candidate not satisfying the one or more bilateral matching conditions, the second CMVP into a second list. Video encoder 200 or video decoder 300 may decode the current block using at least one of the bilateral matching merge list or the second list.

In another example, the candidates that do not satisfy bilateral matching conditions from adjacent positions, non-adjacent positions, temporal positions, and a history buffer will be inserted to the second list. For example, video encoder 200 or video decoder 300 may determine that at least one candidate from an adjacent position, a non-adjacent position, a temporal position, or a history buffer, does not satisfy the one or more bilateral matching conditions. Video encoder 200 or video decoder 300 may insert, based on the at least one candidate from the adjacent position, the non-adjacent position, the temporal position, or the history buffer, not satisfying the one or more bilateral matching conditions, the at least one candidate into the second list.

In another example, only the unsatisfied candidates (e.g., candidates that do not satisfy bilateral matching conditions) from adjacent, non-adjacent positions, and the history buffer will be inserted to the second list.

In another example, only the unsatisfied candidates (e.g., candidates that do not satisfy bilateral matching conditions) from adjacent, non-adjacent and temporal positions will be inserted to the second list.

In another example, only the unsatisfied candidates (e.g., candidates that do not satisfy bilateral matching conditions) from adjacent and non-adjacent positions will be inserted to the second list.

In another example, a second list derivation process is performed after the bilateral matching merge list derivation process is finished. For example, video encoder 200 or video decoder 300 may insert the second CMVP candidate into the second list after the bilateral matching merge list is derived or completed.

In another example, for each candidate in the second list, if the reference block from one of the prediction directions is bi-prediction and the two chained motion vectors satisfy the bilateral matching conditions, the bi-prediction chained motion will be inserted to the merge list (e.g., the bilateral matching merge list).

In another example, for each candidate in the second list, all the available chained motion vectors with a maximum trace depth m are checked and stored in a list. All combinations of two candidates inside the list are tried to form a bi-prediction candidate. If any of the combinations satisfy the bilateral matching conditions, such combinations of candidates will be inserted to the merge list (e.g., the bilateral matching merge list).

In another example, for each candidate in the second list, all the available chained motion vectors with a maximum trace depth m are checked and stored in a list with the source motions. All combinations of two candidates inside the list are tried to form a bi-prediction candidate. If any of the combinations of candidates satisfy the bilateral matching conditions, that combination of candidates will be inserted to the merge list (e.g., the bilateral matching merge list).

For example, video encoder 200 or video decoder 300 may determine which of the candidates in the second list are available chained motion vectors with a maximum trace depth of a predetermined depth. Video encoder 200 or video decoder 300 may store each of the candidates in the second list that are available chained motion vectors with the maximum trace depth of the predetermined depth determined candidates in a third list. Video encoder 200 or video decoder 300 may determine for every combination of two of the stored candidates in the third list, which respective combination satisfies the one or more bilateral matching conditions. Video encoder 200 or video decoder 300 may insert, in the bilateral matching merge list each respective combination of candidates that satisfies the one or more bilateral matching conditions.

In another example, the trace depth m is 1. For example, the predetermined depth may be equal to 1.

In another example, the second list derivation process is performed after the history merge candidate derivation process is finished.

In another example, the second list derivation process is performed after the non-adjacent merge candidate derivation process is finished.

In another example, the second list derivation process is performed after the temporal merge candidate derivation process is finished.

Bi-prediction chained motion vector prediction for bi-prediction source motion is now described. In another example of the disclosure, if the source motion from an existing merge candidate is bi-prediction, at most 2⁽ⁿ⁺¹⁾ bi-prediction chained motion vectors can be derived when the trace depth is n. For an existing merge candidate, at most m candidates can be inserted to the merge list.

In another example, the number m is constrained to 2.

In another example, if the available combinations of chained motion vectors are more than m, a CMVP candidate selection process is performed to select m candidates to insert into the merge list.

In another example, the bi-prediction CMVP candidates are prioritized to be selected.

In another example, the bi-prediction CMVP candidates in which the two reference frames point to different frames are prioritized to be selected.

In another example, the bi-prediction CMVP candidates in which the two reference frames point to same frame are prioritized to be selected.

In another example, the bi-prediction CMVP candidates in which the two reference frames satisfy the bilateral matching conditions are prioritized to be selected.

Bi-prediction chained motion vector with adaptive trace steps is now described. In another example of this disclosure, a bi-prediction CMVP candidate has a first MV on reference picture A in reference list X, wherein the first MV is derived from a temporal trace with a trace step N. The bi-prediction CMVP candidate has a second MV on reference picture B in reference list (1-X), wherein the second MV is derived from a temporal trace with a trace step M.

In one example, the first MV on a reference picture A in reference list X is derived from an N step temporal trace, wherein, N is the smallest traceable step, e.g., N is equal to 1.

In one example, the second MV is derived from an M step temporal trace, wherein M is greater than 1, and M is the smallest traceable step when the second MV is on a reference picture B in reference list (1-X).

Chained motion vector prediction with temporal scaled motion vector is now described. In an example of this disclosure, a CMVP candidate has at least one motion vector that is firstly derived from the temporal trace, and secondly scaled to a reference picture, which may be referred to as CmvpScaledRefPic.

In one example, the CmvpScaledRefPic is predetermined, e.g., the first reference picture in reference picture list X, wherein, X is 0 or 1.

In one example, a CMVP candidate is a bi-prediction candidate, and the first MV is derived from the temporal trace and the first MV is on a reference picture A in reference list X, wherein X is 0 or 1. The second MV is derived from the temporal trace and the second MV is on a reference picture B in reference list X.

In one case, a CmvpScaledRefPic is determined as a reference picture C in reference list (1-X), e.g., reference picture C is the first reference picture in reference list (1-X). The CMVP candidate has a first MV on reference picture A and a second MV on CmvpScaledRefPic, wherein the second MV is temporal scaled from picture B to CmvpScaledRefPic.

In one case, a CmvpScaledRefPic is determined as a reference picture C in reference list (1-X), e.g., reference picture C is the first reference picture in reference list (1-X). The CMVP candidate has a first MV on CmvpScaledRefPic, wherein the first MV is temporal scaled from picture A to CmvpScaledRefPic and a second MV on reference picture B.

In another case, a CmvpScaledRefPic is determined as a reference picture C in reference list (1-X) and minimum POC distance to reference picture A. The CMVP candidate has a first MV on reference picture A and a second MV on CmvpScaledRefPic, wherein the second MV is temporal scaled from picture B to CmvpScaledRefPic.

In another case, a CmvpScaledRefPic is determined as a reference picture C in reference list (1-X) and minimum POC distance to reference picture B. The CMVP candidate has a first MV on CmvpScaledRefPic, wherein the first MV is temporal scaled from picture A to CmvpScaledRefPic and a second MV on reference picture B.

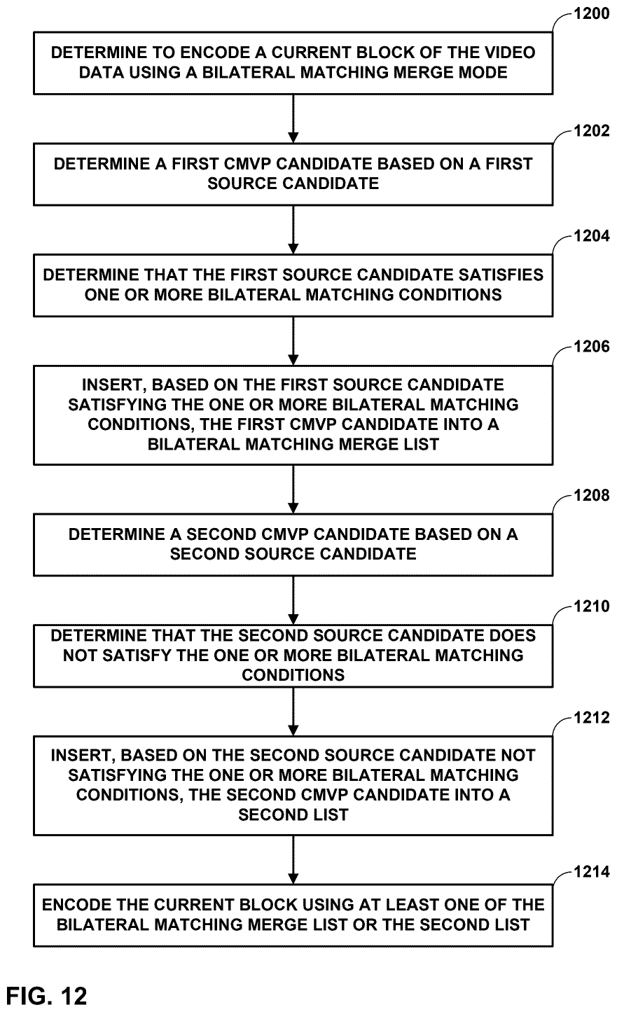

FIG. 12 is a flowchart illustrating an example of chained motion vector prediction techniques according to one or more aspects of this disclosure. Video encoder 200 may determine to encode a current block of the video data using a bilateral matching merge mode (1200). For example, video encoder 200 may determine that a most accurate and/or efficient manner of encoding the current block is to encode the current block using bilateral matching merge mode.

Video encoder 200 may determine a first CMVP candidate based on a first source candidate (1202). For example, video encoder 200 may generate the first CMVP candidate based on the first source candidate.

Video encoder 200 may determine that the first source candidate satisfies one or more bilateral matching conditions (1204). For example, video encoder 200 may determine whether the first source candidate satisfies one or more bilateral matching conditions (e.g., one or more of the DMVR conditions) and may determine that the first source candidate does satisfy those one or more conditions.

Video encoder 200 may insert, based on the first source candidate satisfying the one or more bilateral matching conditions, the first CMVP candidate into a bilateral matching merge list (1206). Video encoder 200 may determine a second CMVP candidate based on a second source candidate (1208). For example, video encoder 200 may generate the second CMVP candidate based on the second source candidate.

Video encoder 200 may determine that the second source candidate does not satisfy the one or more bilateral matching conditions (1210). For example, video encoder 200 may determine whether the second source candidate satisfies one or more bilateral matching conditions (e.g., one or more of the DMVR conditions) and may determine that the second source candidate does not satisfy those one or more conditions (e.g., at least one of the one or more conditions).

Video encoder 200 may insert, based on the second source candidate not satisfying the one or more bilateral matching conditions, the second CMVP candidate into a second list (1212). Video encoder 200 may encode the current block using at least one of the bilateral matching merge list or the second list (1214). For example, video encoder 200 may determine candidate(s) on the second list to add to the bilateral matching merge list as described herein and use the bilateral matching merge list with the added candidate(s) when encoding the current block.

In some examples, video encoder 200 may determine that at least one candidate from an adjacent position, a non-adjacent position, a temporal position, or a history buffer, does not satisfy the one or more bilateral matching conditions. Video encoder 200 may insert, based on the at least one candidate from the adjacent position, the non-adjacent position, the temporal position, or the history buffer, not satisfying the one or more bilateral matching conditions, the at least one candidate into the second list. In some examples, the second CMVP candidate is inserted into the second list after the bilateral matching merge list is derived.

In some examples, video encoder 200 may determine which candidates in the second list are available chained motion vectors with a maximum trace depth of a predetermined depth. Video encoder 200 may store, in a third list, each of the candidates in the second list that are available chained motion vectors with the maximum trace depth of the predetermined depth. Video encoder 200 may determine, for every combination of two stored candidates in the third list, which respective combination satisfies the one or more bilateral matching conditions. For example, video encoder 200 may check each possible combination of two stored candidates in the third list to determine which respective combination satisfies the one or more bilateral matching conditions. Video encoder 200 may insert, in the bilateral matching merge list each respective combination that satisfies the one or more bilateral matching conditions.

In some examples, the predetermined depth is equal to 1. In some examples, as part of storing each of the determined candidates in the third list, video encoder 200 may store a respective source motion for each of the determined candidates.

In some examples, video encoder 200 may determine, for each candidate in the second list, whether a reference block from one of two prediction directions is a bi-predicted reference block and two chained motion vectors associated with the candidate satisfy the one or more bilateral matching conditions. In some examples, video encoder 200 may insert, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

In some examples, video encoder 200 may include a camera configured to capture the video data.

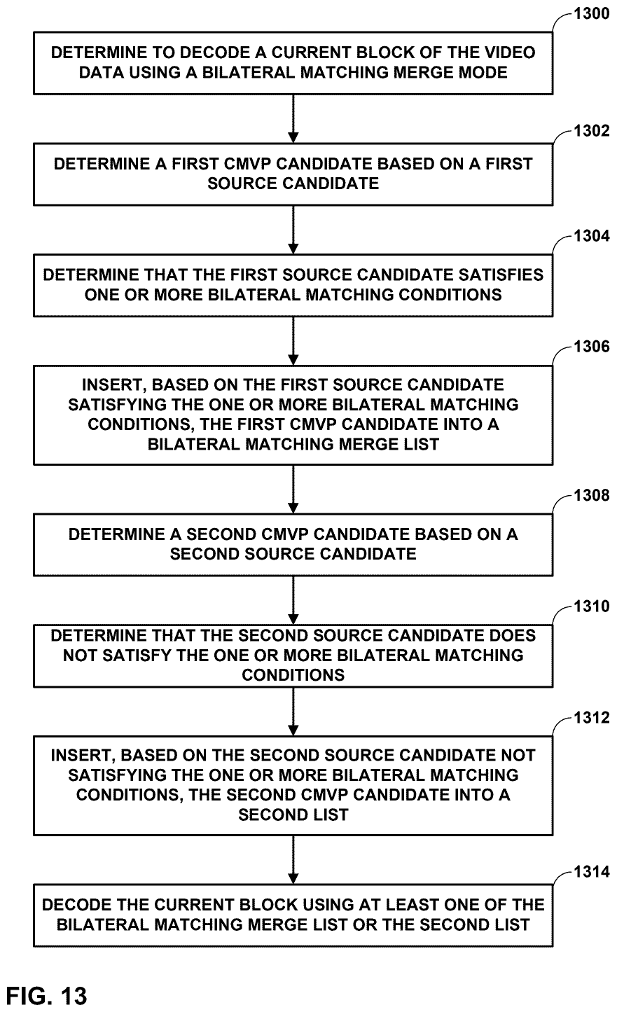

FIG. 13 is a flowchart illustrating another example of chained motion vector prediction techniques according to one or more aspects of this disclosure. Video decoder 300 may determine to decode a current block of the video data using a bilateral matching merge mode (1300). For example, video decoder 300 may parse a flag in a bitstream whose value may be indicative of the current block being encoded using bilateral matching merge mode.

Video decoder 300 may determine a first CMVP candidate based on a first source candidate (1302). For example, video decoder 300 may generate the first CMVP candidate based on the first source candidate.

Video decoder 300 may determine that the first source candidate satisfies one or more bilateral matching conditions (1304). For example, video decoder 300 may determine whether the first source candidate satisfies one or more bilateral matching conditions (e.g., one or more of the DMVR conditions) and may determine that the first source candidate does satisfy those one or more conditions.

Video decoder 300 may insert, based on the first source candidate satisfying the one or more bilateral matching conditions, the first CMVP candidate into a bilateral matching merge list (1306). Video decoder 300 may determine a second CMVP candidate based on a second source candidate (1308). For example, video decoder 300 may generate the second CMVP candidate based on the second source candidate.

Video decoder 300 may determine that the second source candidate does not satisfy the one or more bilateral matching conditions (1310). For example, video decoder 300 may determine whether the second source candidate satisfies one or more bilateral matching conditions (e.g., one or more of the DMVR conditions) and may determine that the second source candidate does not satisfy those one or more conditions (e.g., does not satisfy at least one of the one or more conditions).

Video decoder 300 may insert, based on the second source candidate not satisfying the one or more bilateral matching conditions, the second CMVP candidate into a second list (1312). Video decoder 300 may decode the current block using at least one of the bilateral matching merge list or the second list (1314). For example, video decoder 300 may determine candidate(s) on the second list to add to the bilateral matching merge list as described herein and use the bilateral matching merge list with the added candidate(s) when decoding the current block.

In some examples, video decoder 300 may determine that at least one candidate from an adjacent position, a non-adjacent position, a temporal position, or a history buffer, does not satisfy the one or more bilateral matching conditions. Video decoder 300 may insert, based on the at least one candidate from the adjacent position, the non-adjacent position, the temporal position, or the history buffer, not satisfying the one or more bilateral matching conditions, the at least one candidate into the second list.

In some examples, the second CMVP candidate is inserted into the second list after the bilateral matching merge list is derived.

In some examples, video decoder 300 may determine which candidates in the second list are available chained motion vectors with a maximum trace depth of a predetermined depth. Video decoder 300 may store, in a third list, each of the candidates in the second list that are available chained motion vectors with the maximum trace depth of the predetermined depth. Video decoder 300 may determine for every combination of two stored candidates in the third list, which respective combination satisfies the one or more bilateral matching conditions. Video decoder 300 may insert, in the bilateral matching merge list each respective combination that satisfies the one or more bilateral matching conditions. In some examples, the predetermined depth is equal to 1. In some examples, as part of storing each of the determined candidates in the third list, video decoder 300 may store a respective source motion for each of the determined candidates.

In some examples, video decoder 300 may determine, for each candidate in the second list, whether a reference block from one of two prediction directions is a bi-predicted reference block and two chained motion vectors associated with the candidate satisfy the one or more bilateral matching conditions. Video decoder 300 may insert, for each candidate in the second list that for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

In some examples, video decoder 300 includes a display configured to display decoded video data.

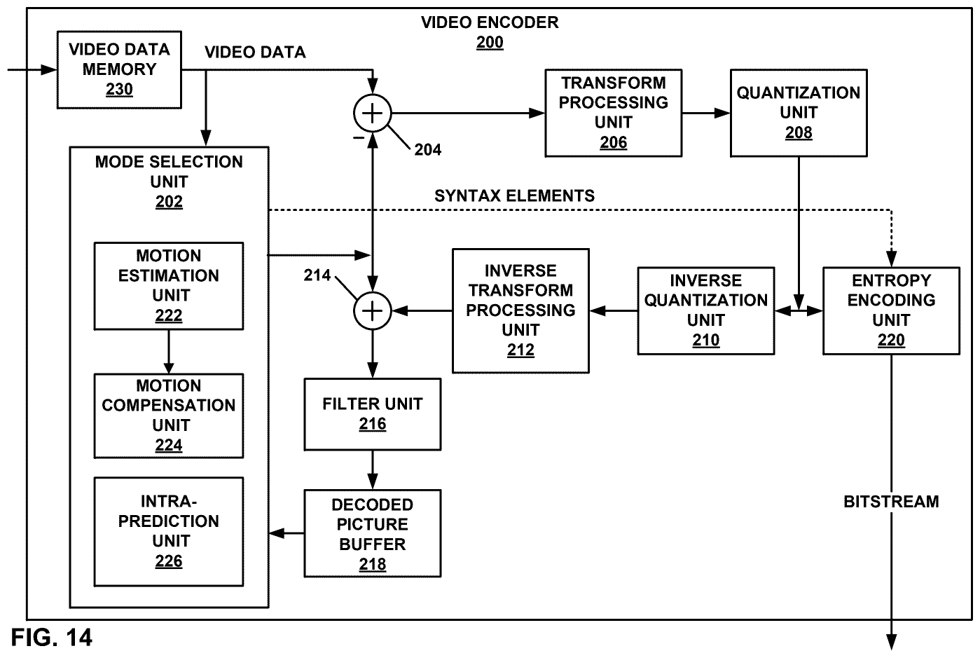

FIG. 14 is a block diagram illustrating an example video encoder 200 that may perform the techniques of this disclosure. FIG. 14 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 14, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 14 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUS, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform any combination of techniques of this disclosure for CMVP.

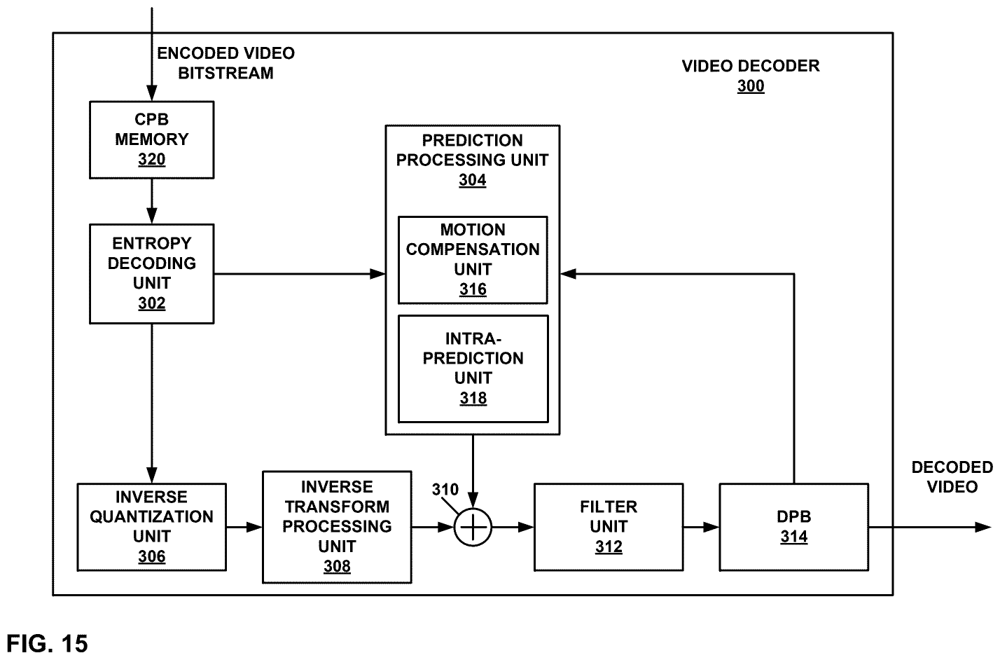

FIG. 15 is a block diagram illustrating an example video decoder 300 that may perform the techniques of this disclosure. FIG. 15 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 15, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 15 are illustrated to assist with understanding the operations performed by video decoder 300. The units may be implemented as fixed-function circuits, programmable circuits, or a combination thereof. Similar to FIG. 14 fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 14).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 14). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform any combination of techniques of this disclosure for CMVP.

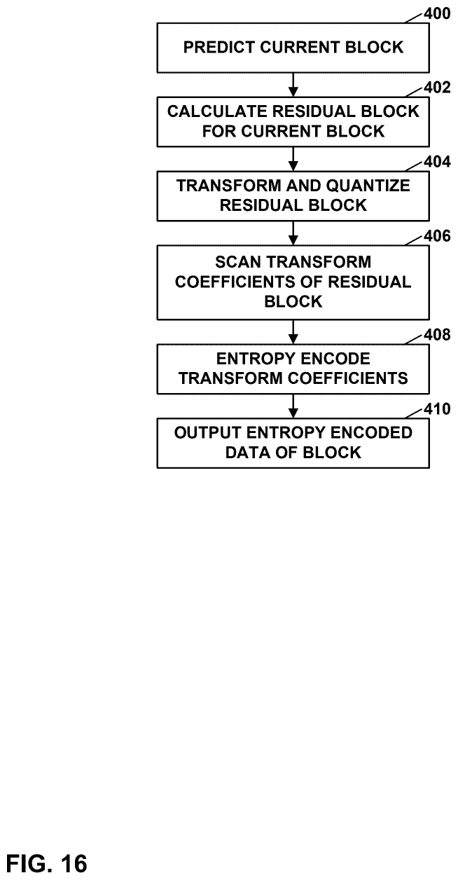

FIG. 16 is a flowchart illustrating an example method for encoding a current block in accordance with the techniques of this disclosure. The current block may be or include a current CU. Although described with respect to video encoder 200 (FIGS. 1 and 14), it should be understood that other devices may be configured to perform a method similar to that of FIG. 16.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

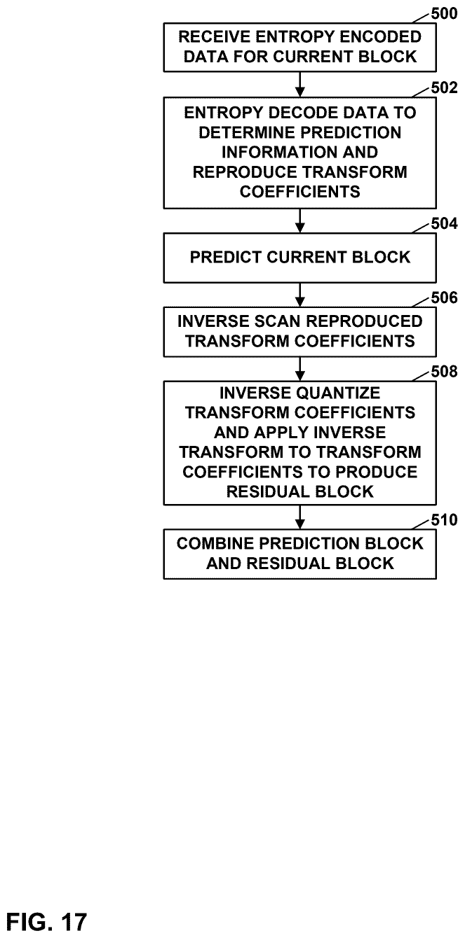

FIG. 17 is a flowchart illustrating an example method for decoding a current block of video data in accordance with the techniques of this disclosure. The current block may be or include a current CU. Although described with respect to video decoder 300 (FIGS. 1 and 15), it should be understood that other devices may be configured to perform a method similar to that of FIG. 17.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

The following numbered clauses illustrate one or more aspects of the devices and techniques described in this disclosure.

Aspect 1A. A method of coding video data, the method comprising: deriving a motion vector for a bilateral matching merge mode candidate using chained motion vector prediction; adding the bilateral matching merge mode candidate to a candidate list; and coding a block of video data using the candidate list.

Aspect 2A. A method of coding video data, the method comprising: restricting a number of bi-prediction chained motion vectors for a merge candidate in the case that source motion for the merge candidate is bi-prediction.

Aspect 3A. A method of coding video data, the method comprising: deriving, for a bi-prediction chained motion vector predictor candidate, a first motion vector on a reference picture A in reference list X from an N step temporal trace, wherein N is a smallest traceable step.

Aspect 4A. A method of coding video data, the method comprising: deriving, for a chained motion vector predictor candidate, at least one motion vector from temporal trace; and scaling the at least one motion vector to a reference picture.

Aspect 5A. The method of any of aspects 1A-4A, wherein coding comprises decoding.

Aspect 6A. The method of any of aspects 1A-4A, wherein coding comprises encoding.

Aspect 7A. A device for coding video data, the device comprising one or more means for performing the method of any of aspects 1A-6A.

Aspect 8A. The device of aspect 7A, wherein the one or more means comprise one or more processors implemented in circuitry.

Aspect 9A. The device of any of aspects 7A and 8A, further comprising a memory to store the video data.

Aspect 10A. The device of any of aspects 7A-9A, further comprising a display configured to display decoded video data.

Aspect 11A. The device of any of aspects 7A-10A, wherein the device comprises one or more of a camera, a computer, a mobile device, a broadcast receiver device, or a set-top box.

Aspect 12A. The device of any of aspects 7A-11A, wherein the device comprises a video decoder.

Aspect 13A. The device of any of aspects 7A-12A, wherein the device comprises a video encoder.

Aspect 14A. A computer-readable storage medium having stored thereon instructions that, when executed, cause one or more processors to perform the method of any of aspects 1A-6A.

Aspect 1B. A method of coding video data, the method comprising: determining to code a current block of the video data using a bilateral matching merge mode; determining a first chained motion vector prediction (CMVP) candidate based on a first source candidate; determining that the first source candidate satisfies one or more bilateral matching conditions; inserting, based on the first source candidate satisfying the one or more bilateral matching conditions, the first CMVP candidate into a bilateral matching merge list; determining a second CMVP candidate based on a second source candidate; determining that the second source candidate does not satisfy the one or more bilateral matching conditions; inserting, based on the second source candidate not satisfying the one or more bilateral matching conditions, the second CMVP candidate into a second list; and coding the current block using at least one of the bilateral matching merge list or the second list.

Aspect 2B. The method of aspect 1B, further comprising: determining that at least one candidate from an adjacent position, a non-adjacent position, a temporal position, or a history buffer, does not satisfy the one or more bilateral matching conditions; and inserting, based on the at least one candidate from the adjacent position, the non-adjacent position, the temporal position, or the history buffer, not satisfying the one or more bilateral matching conditions, the at least one candidate into the second list.

Aspect 3B. The method of any of aspects 1B-2B, wherein the second CMVP candidate is inserted into the second list after the bilateral matching merge list is derived.

Aspect 4B. The method of any of aspects 1B-3B, further comprising: determining which candidates in the second list are available chained motion vectors with a maximum trace depth of a predetermined depth; storing, in a third list, each of the candidates in the second list that are available chained motion vectors with the maximum trace depth of the predetermined depth; determining for every combination of two of stored candidates in the third list, which respective combination satisfies the one or more bilateral matching conditions; and inserting, in the bilateral matching merge list each respective combination that satisfies the one or more bilateral matching conditions.

Aspect 5B. The method of aspect 4B, wherein the predetermined depth is equal to 1.

Aspect 6B. The method of any of aspects 4B-5B, wherein storing in the third list comprises storing a respective source motion for each of the determined candidates.

Aspect 7B. The method of aspect 1B, further comprising: determining, for each candidate in the second list, whether a reference block from one of two prediction directions is a bi-predicted reference block and two chained motion vectors associated with the candidate satisfy the one or more bilateral matching conditions; and inserting, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

Aspect 8B. The method of any of aspects 1B-7B, wherein coding comprises decoding.

Aspect 9B. The method of any of aspects 1B-7B, wherein coding comprises encoding.

Aspect 10B. A device configured to decode video data, the device comprising: one or more memories configured to store the video data; and one or more processors communicatively coupled to the one or more memories, the one or more processors configured to: determine to decode a current block of the video data using a bilateral matching merge mode; determine a first chained motion vector prediction (CMVP) candidate based on a first source candidate; determine that the first source candidate satisfies one or more bilateral matching conditions; insert, based on the first source candidate satisfying the one or more bilateral matching conditions, the first CMVP candidate into a bilateral matching merge list; determine a second CMVP candidate based on a second source candidate; determine that the second source candidate does not satisfy the one or more bilateral matching conditions; insert, based on the second source candidate not satisfying the one or more bilateral matching conditions, the second CMVP candidate into a second list; and decode the current block using at least one of the bilateral matching merge list or the second list.

Aspect 11B. The device of aspect 10B, wherein the one or more processors are further configured to: determine that at least one candidate from an adjacent position, a non-adjacent position, a temporal position, or a history buffer, does not satisfy the one or more bilateral matching conditions; and insert, based on the at least one candidate from the adjacent position, the non-adjacent position, the temporal position, or the history buffer, not satisfying the one or more bilateral matching conditions, the at least one candidate into the second list.

Aspect 12B. The device of any of aspects 10B-11B, wherein the second CMVP candidate is inserted into the second list after the bilateral matching merge list is derived.

Aspect 13B. The device of any of aspects 10B-12B, wherein the one or more processors are further configured to: determine which candidates in the second list are available chained motion vectors with a maximum trace depth of a predetermined depth; store, in a third list, each of the candidates in the second list that are available chained motion vectors with the maximum trace depth of the predetermined depth; determine, for every combination of two stored candidates in the third list, which respective combination satisfies the one or more bilateral matching conditions; and insert, in the bilateral matching merge list each respective combination that satisfies the one or more bilateral matching conditions.

Aspect 14B. The device of aspect 13B, wherein the predetermined depth is equal to 1.

Aspect 15B. The device of any of aspects 13B-14B, wherein as part of storing in the third list, the one or more processors are configured to store a respective source motion for each of the determined candidates.

Aspect 16B. The device of any of aspects 10B-15B, wherein the one or more processors are further configured to: determine, for each candidate in the second list, whether a reference block from one of two prediction directions is a bi-predicted reference block and two chained motion vectors associated with the candidate satisfy the one or more bilateral matching conditions; and insert, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

Aspect 17B. The device of any of aspects 10B-16B, further comprising a display configured to display decoded video data.

Aspect 18B. A method of encoding video data, the method comprising: determining to encode a current block of the video data using a bilateral matching merge mode; determine a first chained motion vector prediction (CMVP) candidate based on a first source candidate; determining that the first source candidate satisfies one or more bilateral matching conditions; inserting, based on the first source candidate satisfying the one or more bilateral matching conditions, the first CMVP candidate into a bilateral matching merge list; determining a second CMVP candidate based on a second source candidate; determining that the second source candidate does not satisfy the one or more bilateral matching conditions; inserting, based on the second source candidate not satisfying the one or more bilateral matching conditions, the second CMVP candidate into a second list; and encoding the current block using at least one of the bilateral matching merge list or the second list.

Aspect 19B. The method of aspect 18B, further comprising: determining that at least one candidate from an adjacent position, a non-adjacent position, a temporal position, or a history buffer, does not satisfy the one or more bilateral matching conditions; and inserting, based on the at least one candidate from the adjacent position, the non-adjacent position, the temporal position, or the history buffer, not satisfying the one or more bilateral matching conditions, the at least one candidate into the second list.

Aspect 20B. The method of any of aspects 18B-19B, wherein the second CMVP candidate is inserted into the second list after the bilateral matching merge list is derived.

Aspect 21B. The method of any of aspects 18B-20B, further comprising: determining which candidates in the second list that are available chained motion vectors with a maximum trace depth of a predetermined depth; storing, in a third list, each of the determined candidates in the second list that are available chained motion vectors with the maximum trace depth of the predetermined depth; determining for every combination of two of stored candidates in the third list, which respective combination satisfies the one or more bilateral matching conditions; and inserting, in the bilateral matching merge list each respective combination that satisfies the one or more bilateral matching conditions.

Aspect 22B. The method of aspect 21B, wherein the predetermined depth is equal to 1.

Aspect 23B. The method of any of aspects 21B-22B, wherein storing in the third list comprises storing a respective source motion for each of the determined candidates.

Aspect 24B. The method of any of aspects 18B-23B, further comprising: determining, for each candidate in the second list, whether a reference block from one of two prediction directions is a bi-predicted reference block and two chained motion vectors associated with the candidate satisfy the one or more bilateral matching conditions; and inserting, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

Aspect 25B. A device configured to encode video data, the device comprising: one or more memories configured to store the video data; and one or more processors communicatively coupled to the one or more memories, the one or more processors configured to: determine to encode a current block of the video data using a bilateral matching merge mode; determine a first chained motion vector prediction (CMVP) candidate based on a first source candidate; determine that the first source candidate satisfies one or more bilateral matching conditions; insert, based on the first source candidate satisfying the one or more bilateral matching conditions, the first CMVP candidate into a bilateral matching merge list; determine a second CMVP candidate based on a second source candidate; determine that the second source candidate does not satisfy the one or more bilateral matching conditions; insert, based on the second source candidate not satisfying the one or more bilateral matching conditions, the second CMVP candidate into a second list; and encode the current block using at least one of the bilateral matching merge list or the second list.

Aspect 26B. The device of aspect 25B, wherein the one or more processors are further configured to: determine that at least one candidate from an adjacent position, a non-adjacent position, a temporal position, or a history buffer, does not satisfy the one or more bilateral matching conditions; and insert, based on the at least one candidate from the adjacent position, the non-adjacent position, the temporal position, or the history buffer, not satisfying the one or more bilateral matching conditions, the at least one candidate into the second list.

Aspect 27B. The device of any of aspects 25B-26B, wherein the second CMVP candidate is inserted into the second list after the bilateral matching merge list is derived.

Aspect 28B. The device of any of aspects 25B-27B, wherein the one or more processors are further configured to: determine which candidates in the second list are available chained motion vectors with a maximum trace depth of a predetermined depth; store, in a third list, each of the candidates in the second list that are available chained motion vectors with the maximum trace depth of the predetermined depth; determine for every combination of two of stored candidates in the third list, which respective combination satisfies the one or more bilateral matching conditions; and insert, in the bilateral matching merge list each respective combination that satisfies the one or more bilateral matching conditions.

Aspect 29B. The device of aspect 28B, wherein the predetermined depth is equal to 1.

Aspect 30B. The device of any of aspects 28B-29B, wherein as part of storing in the third list, the one or more processors are configured to store a respective source motion for each of the determined candidates.

Aspect 31B. The device of any of aspects 25B-30B, wherein the one or more processors are further configured to: determine, for each candidate in the second list, whether a reference block from one of two prediction directions is a bi-predicted reference block and two chained motion vectors associated with the candidate satisfy the one or more bilateral matching conditions; and insert, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

Aspect 32B. The device of any of aspects 25B-31B, further comprising a camera configured to capture the video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining to code a current block of the video data using a bilateral matching merge mode;
determining a first chained motion vector prediction (CMVP) candidate based on a first source candidate;
determining that the first source candidate satisfies one or more bilateral matching conditions;
inserting, based on the first source candidate satisfying the one or more bilateral matching conditions, the first CMVP candidate into a bilateral matching merge list;
determining a second CMVP candidate based on a second source candidate;
determining that the second source candidate does not satisfy the one or more bilateral matching conditions;
inserting, based on the second source candidate not satisfying the one or more bilateral matching conditions, the second CMVP candidate into a second list; and
decoding the current block using at least one of the bilateral matching merge list or the second list.

2. The method of claim 1, further comprising:
determining that at least one candidate from an adjacent position, a non-adjacent position, a temporal position, or a history buffer, does not satisfy the one or more bilateral matching conditions; and
inserting, based on the at least one candidate from the adjacent position, the non-adjacent position, the temporal position, or the history buffer, not satisfying the one or more bilateral matching conditions, the at least one candidate into the second list.

3. The method of claim 1, wherein the second CMVP candidate is inserted into the second list after the bilateral matching merge list is derived.

4. The method of claim 1, further comprising:
determining which candidates in the second list are available chained motion vectors with a maximum trace depth of a predetermined depth;
storing, in a third list, each of the candidates in the second list that are available chained motion vectors with the maximum trace depth of the predetermined depth;
determining for every combination of two of stored candidates in the third list, which respective combination satisfies the one or more bilateral matching conditions; and
inserting, in the bilateral matching merge list each respective combination that satisfies the one or more bilateral matching conditions.

5. The method of claim 4, wherein the predetermined depth is equal to 1.

6. The method of claim 4, wherein storing in the third list comprises storing a respective source motion for each of the determined candidates.

7. The method of claim 1, further comprising:
determining, for each candidate in the second list, whether a reference block from one of two prediction directions is a bi-predicted reference block and two chained motion vectors associated with the candidate satisfy the one or more bilateral matching conditions; and
inserting, for each candidate in the second list for which a reference block from one of two prediction directions is a bi-predicted reference block and the two chained motion vectors associated with the candidate satisfy the one or more bilateral matching conditions, a corresponding bi-prediction chained motion vector prediction candidate into the bilateral matching merge list.

8. The method of claim 1, wherein coding comprises decoding.

9. The method of claim 1, wherein coding comprises encoding.

10. A device configured to decode video data, the device comprising:
one or more memories configured to store the video data; and
one or more processors communicatively coupled to the one or more memories, the one or more processors configured to:
determine to decode a current block of the video data using a bilateral matching merge mode;
determine a first chained motion vector prediction (CMVP) candidate based on a first source candidate;
determine that the first source candidate satisfies one or more bilateral matching conditions;
insert, based on the first source candidate satisfying the one or more bilateral matching conditions, the first CMVP candidate into a bilateral matching merge list;
determine a second CMVP candidate based on a second source candidate;
determine that the second source candidate does not satisfy the one or more bilateral matching conditions;
insert, based on the second source candidate not satisfying the one or more bilateral matching conditions, the second CMVP candidate into a second list; and
decode the current block using at least one of the bilateral matching merge list or the second list.

11. The device of claim 10, wherein the one or more processors are further configured to:
determine that at least one candidate from an adjacent position, a non-adjacent position, a temporal position, or a history buffer, does not satisfy the one or more bilateral matching conditions; and
insert, based on the at least one candidate from the adjacent position, the non-adjacent position, the temporal position, or the history buffer, not satisfying the one or more bilateral matching conditions, the at least one candidate into the second list.

12. The device of claim 10, wherein the second CMVP candidate is inserted into the second list after the bilateral matching merge list is derived.

13. The device of claim 10, wherein the one or more processors are further configured to:
determine which candidates in the second list are available chained motion vectors with a maximum trace depth of a predetermined depth;
store, in a third list, each of the candidates in the second list that are available chained motion vectors with the maximum trace depth of the predetermined depth;
determine, for every combination of two stored candidates in the third list, which respective combination satisfies the one or more bilateral matching conditions; and
insert, in the bilateral matching merge list each respective combination that satisfies the one or more bilateral matching conditions.

14. The device of claim 13, wherein as part of storing in the third list, the one or more processors are configured to store a respective source motion for each of the determined candidates.

15. The device of claim 10, further comprising a display configured to display decoded video data.

16. A device configured to encode video data, the device comprising:
one or more memories configured to store the video data; and
one or more processors communicatively coupled to the one or more memories, the one or more processors configured to:
determine to encode a current block of the video data using a bilateral matching merge mode;
determine a first chained motion vector prediction (CMVP) candidate based on a first source candidate;
determine that the first source candidate satisfies one or more bilateral matching conditions;
insert, based on the first source candidate satisfying the one or more bilateral matching conditions, the first CMVP candidate into a bilateral matching merge list;
determine a second CMVP candidate based on a second source candidate;
determine that the second source candidate does not satisfy the one or more bilateral matching conditions;
insert, based on the second source candidate not satisfying the one or more bilateral matching conditions, the second CMVP candidate into a second list; and
encode the current block using at least one of the bilateral matching merge list or the second list.

17. The device of claim 16, wherein the one or more processors are further configured to:
determine that at least one candidate from an adjacent position, a non-adjacent position, a temporal position, or a history buffer, does not satisfy the one or more bilateral matching conditions; and
insert, based on the at least one candidate from the adjacent position, the non-adjacent position, the temporal position, or the history buffer, not satisfying the one or more bilateral matching conditions, the at least one candidate into the second list.

18. The device of claim 16, wherein the second CMVP candidate is inserted into the second list after the bilateral matching merge list is derived.

19. The device of claim 16, wherein the one or more processors are further configured to:
determine which candidates in the second list are available chained motion vectors with a maximum trace depth of a predetermined depth;
store, in a third list, each of the candidates in the second list that are available chained motion vectors with the maximum trace depth of the predetermined depth;
determine for every combination of two of stored candidates in the third list, which respective combination satisfies the one or more bilateral matching conditions; and
insert, in the bilateral matching merge list each respective combination that satisfies the one or more bilateral matching conditions.

20. The device of claim 16, further comprising a camera configured to capture the video data.
